(19) United States
(12) Patent Application Publication
(10) Pub. No.: US 2023/0263244 A1
(43) Pub. Date: Aug. 24, 2023

(54) VENTILATED COOLING AND PROTECTIVE GARMENT WITH FACIAL SHIELD

(71) Applicant: Mat Product & Technology, SL, Terrassa (ES)

(72) Inventors: Xavier Mateu Codina, Matadepera (ES); Colin Ramsay Bell, Barcelona (ES)

(73) Assignee: Mat Product & Technology, SL, Terrassa (ES)

(21) Appl. No.: 18/005,201

(22) PCT Filed: Jul. 6, 2021
(86) PCT No.: PCT/EP2021/068571

§ 371 Date: Jan. 12, 2023

(30) Foreign Application Priority Data
Jul. 13, 2020 (EP) 20382625.0
Jul. 13, 2020 (ES) U202031524

(51) Int. Cl. A41D 13/005; A41D 13/002; A62B 18/08; A62B 18/00

(52) U.S. Cl. CPC A41D 13/0053; A41D 13/0025; A62B 18/084; A62B 18/003

(57) ABSTRACT

A ventilated cooling and protective garment including a hood portion (31) with a facial opening (14) surrounded by a facial peripheral ring (13) and a complete or partial body portion (32, 33), and a facial shield (10) comprising a transparent shield (11) and a facial peripheral connector (12) supporting and air-tightly attaching the transparent shield (11) to the facial peripheral ring (13) around the facial opening (14), wherein the facial peripheral ring (13) is pulled against the head of the user by the facial shield support (20) and include spacers (13a, 13b) to provide a permeable close non-air-tight fitting between the facial peripheral ring (13) and the head of the used, and an air inlet (A1) is included in the complete or partial body portion (32, 33) and at least a portion of an air outlet (A2) is included in the facial shield (11), or vice versa.

### TECHNICAL FIELD

The present invention relates to a ventilated cooling and protective garment with facial shield integrated therein, said protective garment being connected to an air supply which supplies air producing a cooling effect on the user body by providing a fresh air flow between the protective garment and the user body, and evacuating the heat produced by the user.

At least part of the air supplied by the air supply passes through a facial inner space comprised between the facial shield and the face of the user, introducing breathable air therein free of environmental hazards, helping the user to evacuate heat by breathing fresh air, producing a cooling effect on its face by the impingement of a fresh air flow against the skin, and also preventing the creation of fog in the protective facial shield.

This equipment can be used to protect a user from environmental hazards such toxics, infections, air suspended particles, etc, and is especially suited for hospital environments.

### STATE OF THE ART

The use of ventilated cooling and protective garments with facial shields for protection against environmental hazards is already known.

For example, documents WO2009064555A1 and WO2017074954A1 describe a facial shield including a textile attachment to also protect parts of the body of the user, said facial shield being connected to an air supply to provide a fresh and clean air flow for breathing and also for cooling, but on those documents the air flow introduced in the facial shield cools the face of the user, but on said documents the air flow does not provide a significant cooling to the rest of the user's body.

Document WO2012129396A1 describes a complete body protective garment with facial shield in which an air flow is directed towards the facial shield. In this document also no significant cooling is provided to other areas of the user different to the user's face.

Document U.S. Pat. No. 5,027,807A describe a complete body protective garment with facial shield in which the air flow produced by the air supply is divided in two independent air flows by a valve, one is connected to the facial shield and the other to the protective garment. Because the air flow is divided, more air supply is needed and therefore more energy and a bigger, heavier and more expensive equipment, making difficult the use of a cheap air supply and/or a wearable air supply with batteries.

Document US202006035 describes a complete body protective garment with a facial shield including a ventilation system with a duct and air outlets supported on the head of the user directing the airflow in the space between the face of the user and the facial shield. According to this document, the air is conducted through ducts from the blower device to the air outlet in front of the face of the user, and the air simply escapes from the interior of the garment because it is not hermetically sealed, without a predefined path.

Because, in this document US202006035, the fresh air is conducted through a duct, it does not provide cooling to the user body.

Furthermore, because the garment described in US202006035, and in particular its hood, does not include provisions to be adjusted around the user body the exhaust air will inflate the garment increasing the space between the body and the garment and reducing the flow velocity of the exhaust air, and reducing the cooling effect thereof, to the point of making it negligible.

Document U.S. Pat. No. 4,458,680A describes a complete body protective garment with a facial shield, including an air inlet in the hood and several air exhausts in the garment extremities producing an air flow from the hood to the extremities of the garment. This document specifically mentions as an important feature to have a roomy hood allowing the user to perform manual tasks on its interior, and as in the previous document, does not include provisions to adjusted the garment around the user body, therefore, the exhaust air will inflate the garment increasing the space between the body and the garment and reducing the flow velocity of the exhaust air, and also reducing the cooling effect thereof, to the point of making it negligible.

Document US2003182710 describes a complete body protective garment with a facial shield wherein the hood or portion thereof including the facial shield is made of an elastic material which inflates when an overpressure exists therein, increasing the separation between the hood and the body of the user and reducing the cooling effect in between.

Document WO2020070662A1 describes a complete body protective garment with a facial shield but it is silent on the inclusion of a ventilation or cooling system.

Document EP3225120 describes a cooling garment which lacks hood or facial shield, this garment including two overlapped layers of material with discrete spacers, creating an interspace in between to conduct an air flow. The inner layer further includes openings and discrete spacers directed towards the user body, creating a thin chamber between the garment and the user where the air is insufflated through the openings generating local cooling effect all around the user's body. This solution requires several layers of material and therefore is more expensive. This solution does not provide cooling to the head of the user, one of the hottest parts of the user body, and the air flow does not provide breathable air to the user.

The above and other problems are solved by the proposed invention.

### BRIEF DESCRIPTION OF THE INVENTION

The present invention is directed towards a ventilated cooling and protective garment with facial shield as described in the claims of this document.

This protective garment with facial shield comprises:
a protective garment with an outer layer made of air impermeable or air semi-impermeable material, said protective garment including a hood portion with a facial opening surrounded by a facial peripheral ring and a complete body portion or a partial body portion with one or more body part openings each surrounded by an annular body part tight seal, said hood portion being connected to said complete or partial body portion;
a facial shield comprising:
   a transparent shield covering the facial opening and made of rigid or semi-rigid fluid impermeable and transparent material, and
   a facial peripheral connector, made of a fluid impermeable material, supporting and air-tightly attaching the transparent shield to the facial peripheral ring around the facial opening;
a facial shield support including an adjustment device to tighten the facial shield support around a head of a user, pulling the facial peripheral ring against the head of the user;

an air inlet connectable to an air supply to insufflate air into the ventilated protective garment with facial shield and an air outlet defined by one or more air pressure relieve valves, the air inlet being included in the complete or partial body portion to insufflate air into the protective garment and at least an air outlet being defined by one or more air pressure relieve valves included in the facial shield, or the air inlet being included in the facial shield to insufflate air into the facial shield and the air outlet being defined by one or more air pressure relief valves included in the complete or partial body portion, producing an airflow path between the air inlet and the air outlet at least through the hood portion.

According to that, the proposed invention includes a protective garment which includes an outer layer made of an air impermeable material, which completely prevents the pass of air therethrough, or air semi-impermeable material which mostly prevents the pass of air therethrough when the pressure difference between both sides is less than 10%, only permitting negligible passage of air.

For example, the protective garment can be made of a woven textile or a non-woven textile with a hydrophobic, anti-microbial and/or anti-bacterial treatment.

The protective garment includes a body portion, intended to contain at least part of the body of a user, and a hood portion connected to said body portion and intended to cover the head of said user.

Because the body portion is connected to the hood portion, said body portion contains at least parts of the body of the user adjacent to the head of the user contained in the hood portion.

When the body portion of the protective garment is a complete body portion, the entire body of the user, with the exception of the head contained in the hood portion, can be contained in said complete body portion, including neck, torso and limbs.

When the body portion is a partial body portion, only a part of the body of the user is contained in said partial body portion of the protective garment, including at least the neck of the user and preferably also its torso or part thereof. Portions of the limbs can be also contained within the partial body portion.

According to the invention, the partial body portion will include in addition to the connection with the hood portion, body part openings each surrounded by an annular body part tight seal. Each body part opening is intended to allow the passage of a body part therethrough, and the annular body part tight seal is intended to compress the perimeter of the body part opening against the body part passing through said body part opening providing an air tight seal, allowing a slight pressurization of the interior of the body portion of the protective garment, containing body parts of the user, when the protective garment is worn by said user.

Said body part opening can be, for example, a limb opening such an arm or a leg opening, a chest opening, a waist opening or a hip opening, a wrist opening or an ankle opening.

The protective garment can further include non-ventilated portions with an outer layer made of fluid impermeable material each connected to a body part opening of the partial body portion for containing a body portion but without providing ventilation therethrough. Said non-ventilated portions can be, for example, non-ventilated limb portions.

The body portion will preferably include a zipper, an adhesive band, or other similar air-tight sealing configurations allowing the opening and closing of the protective garment to facilitate the donning and doffing operations thereof.

The connection of the body portion with the hood portion allows the circulation of an air flow between the body portion and the hood portion through said connection.

The hood portion is intended to completely surround the head of the user with the exception of its face, the hood portion being intended to be worn positioning the facial opening thereof in coincidence with the face of the user, which will be surrounded by the facial peripheral ring. Said facial peripheral ring is integrated in the hood portion, surrounding the facial opening.

In addition to the protective garment the present invention further comprises a facial shield.

Said facial shield comprises a transparent shield covering the facial opening and air-tight connected to the facial peripheral ring of the hood portion through a facial peripheral connector.

The user can see through the transparent shield, positioned in front of its face, and will breath the air contained in a facial inner space defined between the transparent shield and the user's face and surrounded by the facial peripheral connector and the facial peripheral ring.

The space surrounded by the protective garment with facial shield, containing parts or all the body of the user including its head, further comprises an air inlet connectable to an air supply to insufflate air within said space and an air outlet, comprising one or more air pressure relieve valves, to exhaust the air contained within said space when the pressure therein reaches certain predetermined pressure, for example when the user exhales air into said inner space.

The facial shield support is intended to be placed around the head of a user and include an adjustment device which allows the tight adjustment of said facial shield support around the head of the user. The ventilated protective facial shield is supported on said facial shield support, so that the adjustment of the facial shield support pulls the facial peripheral ring against a peripheral region of the face of the user.

The facial shield support will be preferably connected to symmetric positions of the facial peripheral connector, or the facial peripheral ring, preferably at mostly regular intervals.

The transparent shield being supported only on said facial peripheral ring through the facial peripheral connector. Because no pulling forces are transmitted through the transparent shield, it can be very thin, light and therefore affordable, its weight being only supported through the facial peripheral connector. Because the reduced weight of the transparent shield said facial peripheral connector can be made of a flexible material or textile material and at the same time able to support the transparent shield weight.

The adjustment device of the facial shield support can be, for example, a buckle, a ladder lock buckle and/or at least a portion of the facial shield support being elastic.

The air insufflated into the inner space provides fresh breathable air, produces a cooling effect, and prevents fogging of the transparent shield.

The ventilated cooling and protective facial shield protect from environment hazards and also prevents the free dispersion of suspended micro droplets of saliva from the facial shield user, which could potentially contain pathogens, released by speaking, breathing, coughing, or sneezing.

Said air supply can obtain the insufflated air from a clean air source or can include an air filter to filter the insufflated air to increase the protection of the user.

The air supply provides a pressurized air flow and can be, for example, an air pump, an air fan, or a compressed air deposit.

The air outlet can also include an air filter to improve the prevention of micro droplets dispersion.

The present invention further comprises the following features, which are not known from the available state of the art.

the airflow path is set to produce a cooling airflow on the user body by:
spacers included on the facial peripheral ring to provide a permeable close non-air-tight fitting between the facial peripheral ring and the head of the used, to generate a cooling airflow passing through said close non-air-tight fitting, cooling the parts of the user in contact with the facial peripheral ring and surrounding areas; and/or
tightening means of the hood portion adapted to tighten the hood portion around a head of a user, to define a narrow chamber between the hood portion and the user's head, to generate a cooling airflow close to the head of the user there around.

According to that, the airflow path is adapted to maximize the cooling effect produced by the airflow on the user's body.

According to one alternative option, the facial peripheral ring, when pulled against the head of the user by the facial shield support, does not produce an air-tight fitting against the user's head allowing the passage of an air flow between the facial peripheral ring and the user's head, creating a cooling effect on this area of the user's head and also in the surrounding areas.

According to another alternative option, the hood portion further includes tightening means, i.e. a configuration adapted to tighten the hood portion around the head of the user to reduce the free space therein, channeling the air low close to the user's head, increasing the airflow velocity and the cooling effect on the user's skin.

As tighter the fitting of the hood portion around the user head, smaller is the chamber between the hood portion and the user's head and faster the air flow passing there through, producing a much higher cooling effect.

Said tightening means can be, for example, an additional adjustment device included in the hood portion, different from the adjustment device of the shield support.

Alternatively, the tightening means can be the adjustment device of the shield support, the hood portion being integrated in the shield support. In this case, the facial shield support can be connected to the facial peripheral ring, providing support to the weight of the attached transparent shield, being integrated in the hood portion, for example attached to its inner or outer surface, producing an approaching of the hood portion to the head of the user when in use.

Optionally, the hood portion can be adapted to be the facial shield support itself and to be tightened around the head of a user by the adjustment device, which acts as the tightening means. In this case the adjustment device will be also integrated in the hood portion and will be intended to tighten the hood portion around the head of a user.

By approaching the hood portion around the user head, the air flow conducted between the hood portion and the user's head is approached to the user's head and is accelerated, because the flowing space is reduced, increasing its cooling effect on the user's head.

Alternatively, the hood portion can be made of an elastic material set to tighten the hood portion around a head of the user and to prevent the inflation of the hood portion by the inner air pressure, said elastic material acting as tightening means. Typically, the air pressure within the protective garment will be a small overpressure lower than 10% or 5% or 2% above the ambient pressure. If the elastic force produced by the elastic material around the head of the user is higher than said 10%, 5% or 2% above the ambient pressure, the inflation thereof will be avoided. In this case, the hood portion can be separated from the shield support, can be integrated therewith or can be simultaneously the shield support and the respective adjustment device.

According to an additional embodiment of the present invention, at least a portion, or at least a torso portion, of the partial or complete body portion of the protective garment is adapted to be tightened around the body of the user, also to increase the cooling effect produced by the air flow passing there through.

For example, the cited portion of the protective garment can be adapted to be tighten around the body of the user by an additional adjustment device or can be made of an elastic material set to tighten the protective garment around a body of the user and to prevent the inflation of the protective garment by the inner air pressure.

It is also proposed to include the air inlet in the complete or partial body portion of the protective garment and at least a portion of the air outlet in the facial shield, it is to say in the transparent shield or in the facial peripheral connector. The air insufflated in the complete or partial body portion of the protective garment from the air supply will flow between the complete or partial body portion and the user, producing a cooling effect on the user, and will reach the hood portion, flowing around and cooling the head of the user. Then said air flow will reach, from the hood portion and through the facial opening, a facial inner space defined between the facial shield and the face of the user passing through said close non-air-tight fitting between the facial peripheral ring and the user's head.

This solution allows the use of the same air flow to cool the body, or the body portion of the user contained in the complete or partial body portion of the protective garment, the user's head contained in the hood portion of the protective garment and also the face of the user, and also using said same air flow as a breathable air and to prevent the fogging of the transparent shield.

Because said non-air-tight fitting between the facial peripheral ring and the user's head is close to the user's face, the air flow is directed to flow adjacent to the user's face and adjacent to the user's head, increasing the cooling feeling and projecting the air flow against the transparent shield.

In an alternative solution the air inlet is included in the facial shield, and the air outlet is at least partially included in the complete or partial body portion, producing the air flow in the inverse direction, flowing from the facial inner space to the rest of the protective garment.

According to an embodiment of the present invention, the facial peripheral ring includes, in a surface directed towards the interior of the hood portion, discrete protruding spacers or an annular open mesh spacer intended to keep an air-permeable gap between the facial peripheral ring and the head of the user.

The facial peripheral connector can include a releasable seal, for example a seal selected among a zipper seal, a magnetic seal, a Velcro seal or a snap fit seal, allowing the separation of the transparent shield from the protective garment. This could be helpful to allow the user to rest for a moment, clean the face or the inner side of the transparent shield, take a drink, blow his nose.

Also allow the separation of the transparent shield from the rest of the protective garment, allowing cleaning or disinfection treatments of the transparent shield or even its substitution, and also permitting the cleaning or disinfection of the rest of the protective garment without the rigid or semi-rigid transparent shield attached thereto, which could make difficult said cleaning and disinfection operations.

According to one embodiment of the present invention, the air outlet of the facial shield is integrated in the facial peripheral connector, it is to say that one or several air pressure relieve valves are included on said facial peripheral connector, between the transparent shield and the facial peripheral ring.

It is also proposed to include a plurality of discrete protruding spacer nodes on an inner side of the hood portion and/or of the partial or complete body portion. Those discrete protruding spacer nodes will separate the inner side of the protective garment from the user, creating air flow channels through which the air flow can flow near the user producing a cooling effect. Said discrete protruding spacer nodes can be included in the hood portion and/or in the complete or partial body portion.

Said discrete protruding spacer nodes will have preferably a height smaller than 3 mm.

Additionally, or alternatively, at least a portion of the protective garment can include an inner perforated layer spaced from the outer layer by a plurality of discrete protruding spacer nodes placed in between, attached to the outer layer and/or to the inner layer, and an inner side of the inner perforated layer will also include a plurality of discrete protruding spacer nodes to create a separation between the inner perforated layer and the user.

In this embodiment the air source is connectable to the sealed space defined between the outer layer and the inner perforated layer to provide an air flow in said space.

The air flow provided by the air source will be a turbulent air flow, which will flow between the outer layer and the inner perforated layer. Said air flow will pass through the inner perforated layer through said perforations which are configured to each produce a laminated air beam directed towards the user to increase the cooling effect.

The discrete protruding spacer nodes separating the inner perforated layer from the user will also separate the perforations of the inner perforated layer from the user, increasing the surface area of the user cooled by each single laminated air beam.

Thanks to those features a low air flow with low pressure can cool a big portion of the user surface, reducing power needs of the air source and its weight and cost.

This is particularly interesting because a low weight and low consumption air source allows the use of a wearable air source such a fan activated with batteries.

It is also proposed to include an annular track formed in the transparent shield as an integral part thereof, made of the same material. The facial peripheral connector will be attached and retained to said annular track through an annular coupling configuration complementary to said annular track and tightly fitted thereto.

According to that, the transparent shield is shaped to define said annular track where the facial peripheral connector is air-tightly coupled.

It should be understood that the annular track is an elongated configuration, defined on the material constitutive of the transparent shield, with a cross section of a constant shape and size. According to that, the annular track can be defined as a groove or as a protruding rail with a cross section of a constant size and shape.

The facial peripheral connector includes an annular coupling configuration which is complementary to the annular track to provide an air-tight attachment therewith when coupled.

It should be understood that the annular coupling configuration is an elongated configuration with a cross section of a constant shape and size, being said shape and size complementary to the shape and size of the annular track cross section.

When the annular track is a groove, the annular coupling configuration is adapted to be tightly inserted within said groove. When the annular track is a protruding rail, the annular coupling configuration will include a groove where said protruding rail can be tightly inserted providing attachment.

Preferably the attachment between the annular track and the annular coupling configuration prevents the uncoupling in a direction perpendicular to the transparent shield or requires a certain intentional releasing force above a certain threshold of accidental forces to produce an uncoupling in said perpendicular direction, for example a force above 1 kg or 10N.

Preferably the transparent shield is approximately half an eggshell in shape, it is to say that its outer surface is defined by a positive gaussian curvature and its inner surface by a negative gaussian curvature. This shape makes the transparent shield closer to the user's face perimeter, reducing the separation to be covered by the facial peripheral connector, which reduces its cost, weight and aesthetical impact.

Preferably said annular track is defined in an inner side of the transparent shield directed towards the facial opening.

The transparent shield could extend beyond the annular track on the upper region thereof defining an upper support intended to be vertically supported on a top area of the head of the user directly or through an intermediate padding element attached to an inner side of the upper support.

The upper support will transmit most of the vertical load produced by the transparent shield weight to the top area of the user's head, reducing the load transmissions through the facial peripheral connector.

The transparent shield can be made of a plastic sheet.

Preferably said plastic sheet will be a thermoformed plastic sheet, such as a sheet of transparent Polyethylene terephthalate (PET), in which case the annular track will be formed by bends of said plastic sheet.

Alternatively, the transparent shield is made of a molded plastic, such as transparent polycarbonate, in which case the annular track will be molded on said plastic.

The transparent shield can further include, on at least one of its surfaces, at least one of the following: an anti-scratch treatment; an anti-fog treatment; a hydrophobic treatment; an anti-microbial treatment; an anti-bacterial treatment; an anti-glare treatment; a light filtering treatment; a photo-chromic treatment.

The facial shield can further comprise at least one of the following, connected to a battery and to a control unit: a handsfree microphone and/or speaker; a head-up display; a front-facing camera; a user-facing camera; outer temperature and/or pressure sensor; inner temperature and/or pressure sensor; user temperature, breathing and/or cardiac sensor; wireless connection antenna; battery status sensor.

The outer temperature and/or pressure sensor measure the temperature and/or pressure of the ambient air exterior to the facial inner space, and the inner temperature and/or pressure sensor measure the temperature and/or pressure of the air contained within the facial inner space.

The control unit can also be connected to the air supply to regulate the insufflated air in response to the user temperature, breathing and/or cardiac measurements obtained from the sensors and/or from the inner or outer temperature and/or pressure measurements obtained from the sensors.

The control unit is connected to a battery, both elements being carried by the user. The air supply can be a wearable air supply such a fan connected to a battery. Both batteries can be the same battery using a single battery status sensor or can be independent batteries each with an independent battery status sensor.

Other features of the invention appear from the following detailed description of an embodiment.

### BRIEF DESCRIPTION OF THE FIGURES

The foregoing and other advantages and features will be more fully understood from the following detailed description of an embodiment with reference to the accompanying drawings, to be taken in an illustrative and non-limitative manner, in which:

FIG. 1 shows a ventilated cooling and protective garment according to a first embodiment;

FIG. 2 shows a ventilated cooling protective garment according to a second embodiment;

FIG. 3 shows an ampliated view of the hood portion with the facial shield according to the first embodiment shown on FIG. 1.

FIGS. 4 and 5 shown an ampliated view of a cross section of the facial peripheral connector, including a pressure relieve valve and a releasable seal, according to an embodiment in which the annular track is a protruding rail (FIG. 4) or a groove (FIG. 5) molded in the inner side of the transparent shield;

FIGS. 6 and 7 shown an ampliated view of a cross section of the facial peripheral connector, including a pressure relieve valve and a releasable seal, according to an embodiment in which the annular track is a protruding rail (FIG. 6) or a groove (FIG. 7) defined by bending of the transparent shield obtained by thermoforming;

FIGS. 8, 9 and 10 shown a cross section of a portion of the ventilated cooling and protective garment according to an embodiment including an outer layer with discrete protruding spacer nodes on its inner side (FIG. 8), or with a perforated inner layer including discrete protruding spacer nodes on its inner side and separated from the outer layer by discrete protruding spacer nodes attached to the inner side of the outer layer (FIG. 9) or in the outer side of the perforated inner layer (FIG. 10).

### DETAILED DESCRIPTION OF AN EMBODIMENT

The foregoing and other advantages and features will be more fully understood from the following detailed description of an embodiment with reference to the accompanying drawings, to be taken in an illustrative and not limitative, in which:

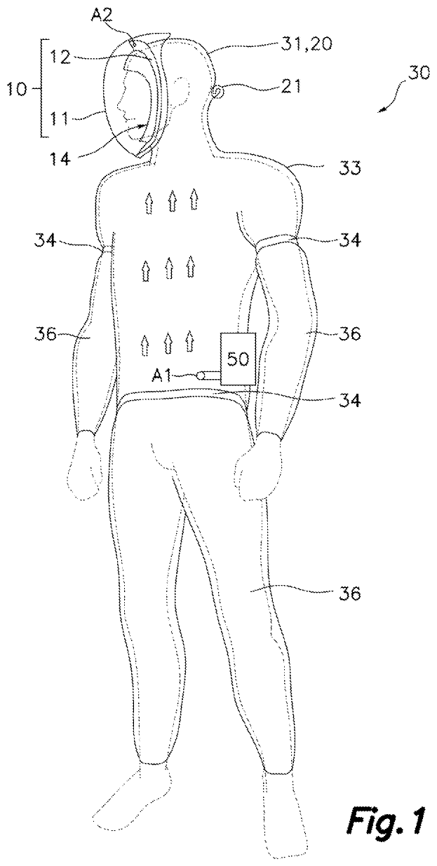

FIG. 1 shows a ventilated cooling and protective garment including a facial shield 10 and a protective garment 30 which, in this embodiment, includes a hood portion 31 and a partial body portion 33 intended to cover neck, shoulders and torso of a user.

The protective garment includes an outer layer 30a made of an air impermeable or semi-impermeable material, such a non-woven material.

The hood portion 31 includes a facial opening 14 surrounded by a facial peripheral ring 13 intended to surround the face of the user.

The facial shield 10 includes a transparent shield 11, which is approximately half an eggshell in shape, covering the facial opening 14 of the hood portion 31, air-tightly connected to the facial peripheral ring 13 by a facial peripheral connector 12, which is a ring connector with an inner edge connected to the facial peripheral ring 13 and with an outer edge connected to an inner side of the transparent shield 11, defining a facial inner space intended to contain the user's face.

An inner side of the facial peripheral ring 13, facing the interior of the hood portion 31, include spacers, which could be discrete protruding spacers 13a or an annular open mesh spacer 13b intended to keep an air-permeable gap between the facial peripheral ring 13 and the head of the user, preventing the air-tight sealing between the facial peripheral ring 13 and the user's head, allowing a circulation of an air flow between the facial inner space and the interior of the hood portion 31.

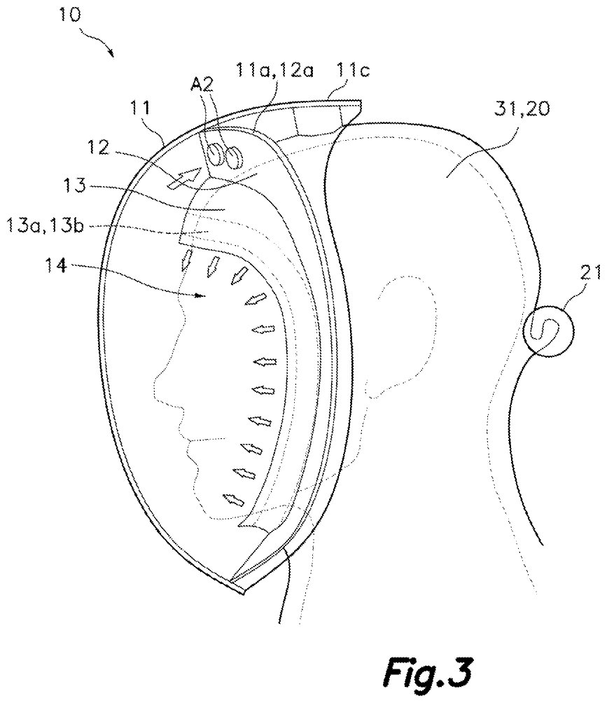

According to the embodiment shown in FIG. 3, the facial peripheral connector 12 includes multiple pressure relieve valves which determine an air outlet A2. Said pressure relieve valves are configured to allow exit of the air contained in the facial inner space when the pressure is higher than the ambient pressure and to prevent the entrance of ambient air into the facial inner space.

To ensure a close fitting between the facial peripheral ring 13 and the user's head, the hood portion 31 further includes a facial shield support 20 including an adjustment device 21 configured to tighten the facial shield support 20 around the user's head, compressing the facial peripheral ring 13 against the user's head.

According to the embodiment shown on FIGS. 1 and 3 the facial shield support 20 is the portion hood 31 of the protective garment 30 which, when tighten by the adjustment device 21, stretches around the user's head and pulls the facial peripheral ring 13 against the user's head.

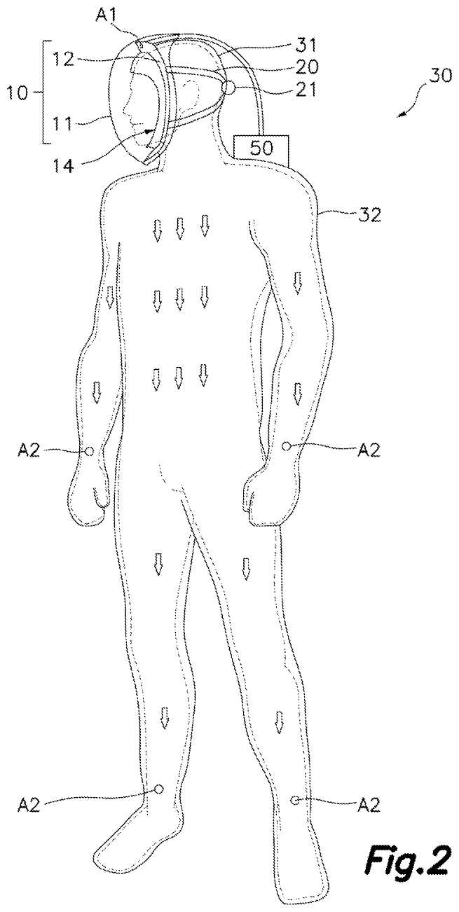

According to an alternative embodiment shown on FIG. 2 the facial shield support 20 are several harnesses surrounding the user's head and connected to the facial peripheral ring 13 or to the transparent shield 11, for example two, three, four, five or six harnesses.

The partial body portion 33 is connected to the hood portion 31 and further comprises three body part openings each surrounded by a annular body part tight seal 34, one for tightly surrounding the waist of the user and two more for tightly surround the two arms of the user, so that the protective garment 30 define an inner space comprised between the user body and the protective garment 30 covering torso, shoulders, neck and head of the user.

It will be understood that the partial body portion 33 could also cover other areas of the user body such the arms and legs, in which case the body part openings will be four and the annular body tight seals 34 will be intended to surround the user's wrists and ankles.

In this particular embodiment shown on FIG. 1 non-ventilated garment portions 36, made of air impermeable or air semi-impermeable material, are attached to the annular body part tight seals 34 and intended to cover additional parts of the user's body not covered by the ventilated cooling and protective garment, in this embodiment the arms and legs, offering protection against environmental hazards but without providing ventilation.

In this embodiment, the partial body portion 33 of the protective garment 30 further comprises at least one air inlet A1 adjacent to the body part opening corresponding to the waist of the user.

Said air inlet A1 is connected to one wearable air supply 50 carried by the user, for example supported from the user shoulders as a backpack or as a shoulder bag, or from the user's waist as a fanny bag.

The air supply 50 comprises a fan actuated by an electric motor connected to an electric battery, and optionally it can further include an air filter. The air supply 50 blows an air flow into the protective garment through the air inlet A1.

The air flow circulates within the protective garment 30 from the air inlet A1 to the air outlet A2 of the facial shield 10, included in the facial peripheral connector 12, flowing between the outer layer 30a of the protective garment 30 and the user. This air flow produces a cooling effect on the part of the user's body contained in the partial protective garment 33 and the user's head, and later said air flow enters in the facial inner space through the close non-air-tight fitting between the user's head and the facial peripheral ring 13, cooling the user's face and preventing the creation of fog on the transparent shield 11.

According to an alternative embodiment, shown on FIG. 2, the facial shield 10 includes an air inlet A1 directly connected to the air supply 50, in this case as a backpack, and the complete body portion 32 of the protective garment 30 include several air outlets A2, each including at least one pressure relive valve, away from the hood portion 31, in this example at the extreme ends of each limb. This configuration produces an air flow from the facial inner space towards the air outlets A2 cooling the entire body of the user, The air flow passes from the facial shield 10 to the hood portion 31 through said close non-air-tight fitting between the facial peripheral ring 13 and the user's head, cooling the face and the head of the user, and later flowing through the complete body portion 32 of the protective garment 30.

It will be obvious that said descending air flow from the facial shield 10 towards the protective garment 30 can be implemented using a partial body portion 33 and that the ascending air flow from the protective garment 30 towards the facial shield 10 described above can be implemented using a complete body portion 32.

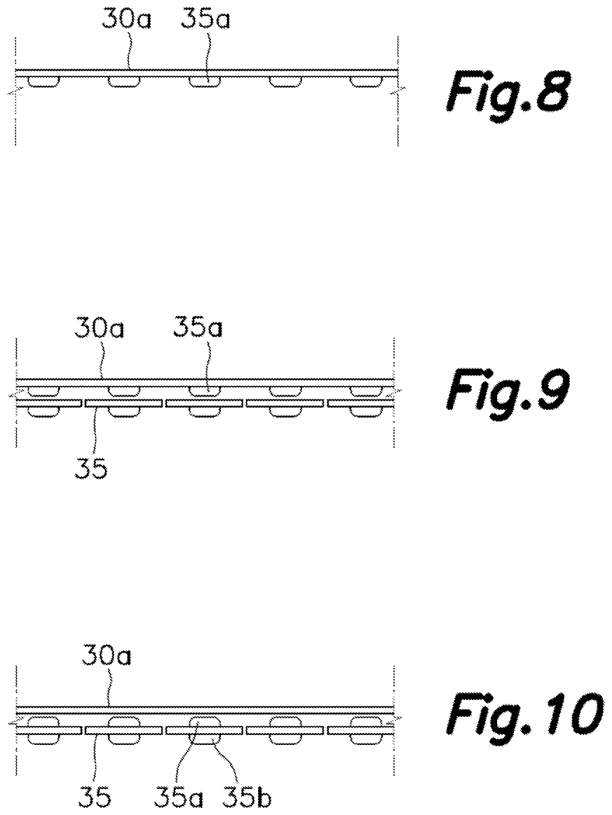

Preferably, the inner side of the outer layer 30a of the protective garment 30 facing the user's body, or parts thereof, includes discrete protruding spacer nodes 35a which protrude separating the inner side of the outer layer 30a from the user, creating an interspace through which the air flow can circulate close to the user, as shown on FIG. 8.

A close fitting of the protective garment to the user is preferred, because as close is the fitting more rapidly the air flow circulates, and higher cooling effect is achieved. Therefore, it is preferred to include adjustment devices also to the complete or partial body portion 32, 33 to tighten the complete or partial body portion 32, 33 of the protective garment 30 around the body of the user.

According to an alternative or additional embodiment, shown on FIGS. 9 and 10, the protective garment 30, or parts thereof, it further includes a perforated inner layer 35 parallel to the outer layer 30a and separated thereof by the interposed discrete protruding spacer nodes 35a, creating an interspace through which the air flow can circulate. The discrete protruding spacer nodes 35a can be attached to the inner side of the outer layer 30a or to the outer side of the perforated inner later 35.

Said perforated inner layer 35 further comprises additional discrete protruding spacer nodes 35b on its inner side facing the user, to separate said perforated inner layer 35 from the user.

The air inlet A1 is communicated with said interspace, blowing an air flow into said interspace through which the air flow freely circulates through the part of the protective garment 30 including said perforated inner layer 35.

Said outer layer 30a and perforated inner layer 35 shall be air-tightly joined together on its perimeter, so that the air can only exit the interspace through the perforations of the perforated inner layer 35. The air flow contained in the interspace creates an overpressure on said interspace, urging the air to flow out of the interspace through the perforations included on the perforated inner layer 35.

Said perforations are configured to produce a lamination effect on the air flow, which increases its cooling effect, and because the perforated inner layer 35 is separated from the user by the additional discrete protruding spacer nodes 35b, each air jet ejected from each perforation produces a cooling effect on an area much wider than the perforation size. Thanks to those features, a small air stream can produce a cooling effect on a wide area.

In the preferred embodiment, the partial body portion 33 include said inner layer 35 at least on the front and back sides of the partial body portion 33 covering the user's torso. It is also preferred to include, on the inner side of the hood portion 31, the discrete protruding spacer nodes 35a to facilitate the circulation of the air flow around the user's head.

According to a preferred embodiment, said discrete protruding spacer nodes 35a, 35b are made of printed expanding ink. It is also proposed to include discrete protruding spacer nodes 35a, 35b with an orientation and shape to direct the air flow towards a desired direction, acting as deflectors.

The discrete protruding spacers 13a included on the inner side of the facial peripheral ring 13 can also be made of printed expanded ink.

When said spacers are an annular open mesh spacer 13b, the it is proposed to use for example an air permeable foam adhered to the inner side of the facial peripheral ring 13.

The facial peripheral connector 12, which connects the transparent shield 11 to the facial peripheral ring 13, also separates the transparent shield 11 from the user's face creating the facial inner space and transmits the transparent shield 11 weight to the facial peripheral ring 13.

It is proposed to connect the facial peripheral connector 12 to the transparent shield 11 through an annular coupling configuration 12a defined on the outer edge of the facial peripheral connector 12 tightly coupled to an annular track 11a included in the inner side of the transparent shield 11 facing the user's head, surrounding a central region of the transparent shield 11 covering the facial opening 14 of the hood portion 31.

The annular coupling configuration 12a and the annular track 11a will have complementary shapes and sizes, allowing for a tight fitting between them and preventing an accidental extraction by pulling in a transverse direction perpendicular to the transparent shield 11 surface.

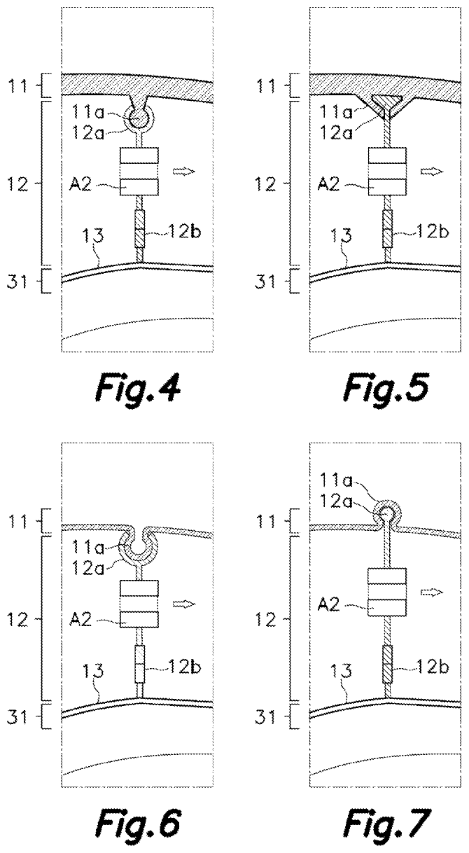

According to examples shown on FIGS. 4 and 6 the annular track 11a can be a protruding rail defined by a longitudinal protrusion of the inner surface of the transparent shield 11 with a longitudinal bulging end, in which case the annular coupling configuration 12a include a longitudinal groove intended to accommodate in its interior the protruding rail, surrounding and retaining the bulging end.

Alternatively, according to examples shown on FIGS. 5 and 7, the annular track 11a is a longitudinal groove with an access slit, the longitudinal groove being wider than the access slit, in which case the annular coupling configuration 12a is inserted in the longitudinal groove through the access slit and include a longitudinal bulging end contained and retained in the groove.

In any case, the annular coupling configuration 12a can be coupled to the annular track 11a by sliding the annular coupling configuration 12a from an access point or interruption of the annular track 11a where said annular track 11a is interrupted, or can be attached by a snap fit, producing an elastic deformation of the elements to be coupled by pressing.

FIGS. 4 and 5 shown embodiments in which the annular track 11a is molded together with the rest of the transparent shield 11.

Alternatively, FIGS. 6 and 7 shown embodiments in which the transparent shield 11 is made of a thermoformed plastic layer and wherein the annular track 11a is defined by bends of said plastic layer which define the groove or rail constitutive of the annular track 11a.

The facial peripheral connector 12 can further include a releasable seal 12b, permitting the coupling and uncoupling of the transparent shield 11 to the rest of the protective garment 30, allowing the user to access his face and mouth without having to remove the suit, for example for cleaning, eating, drinking, blow the nose, and also allowing the cleaning of the inner side of the transparent shield 11. This feature also permits the separation of the transparent shield 11 from the rest of the protective garment 30, allowing the substitution of the transparent shield 11, the reuse of the transparent shield with a different single use protective garment 30, or differentiated cleaning treatments of the transparent shield 11 and the protective garment 30.

Said releasable seal 12b will be preferably a zipper producing a tight coupling, but other alternatives are also contemplated, for example a magnetic coupling, Velcro or re-adherable adhesives such sensitive adhesives, among others.

It will be understood that various parts of one embodiment of the invention can be freely combined with parts described in other embodiments, even being said combination not explicitly described, provided that such combination is within the scope of the claims and that there is no incompatibility in such combination.

1. A ventilated cooling and protective garment comprising:
an outer layer comprising an air impermeable material or an air semi-impermeable material, the outer layer comprising a hood portion connected to: a partial body portion with one or more body part openings each one surrounded by an annular body part tight seal, or to a complete body portion, the hood portion comprising a facial opening surrounded by a facial peripheral ring;
a facial shield comprising a transparent shield covering the facial opening and, a facial peripheral connector made of a fluid impermeable material air-tightly attaching the transparent shield to the facial peripheral ring of the hood portion; and a facial shield support comprising an adjustment device configured to tighten the facial shield support around a head of a user, and configured to pull the facial peripheral ring against the head of the user; and
an air inlet disposed on the complete or partial body portion and configured to insufflate air into the protective garment and at least an air outlet defined by one or more air pressure relieve valves included in the facial shield, or an air inlet disposed on the facial shield and configured to insufflate air into the facial shield and an air outlet defined by one or more air pressure relieve valves included in the complete or partial body portion, producing an airflow path between the air inlet and the air outlet at least through the hood portion;
an airflow path being set to produce a cooling airflow on the user body by: spacers disposed on the facial peripheral ring and configured to provide a permeable close non-air-tight fitting between the facial peripheral ring and the head of the used, the spaces further configured to generate a cooling airflow passing through the close non-air-tight fitting, cooling the parts of the user in contact with the facial peripheral ring and surrounding areas; and/or
a tightening device of the hood portion adapted to tight the hood portion around a head of a user, the tightening device further configured to define a narrow chamber between the hood portion and the user's head and to generate a cooling airflow close to the head of the user.

2. The ventilated cooling and protective garment according to claim 1 wherein the spacers are discrete protruding spacers or an annular open mesh spacer configured to keep an air-permeable gap between the facial peripheral ring and the head of the user, the spaces being disposed on a surface of the facial peripheral ring and being directed towards an interior of the hood portion.

3. The ventilated cooling and protective garment according to claim 1 wherein the tightening device is:
an additional adjustment device, different to the adjustment device to tighten the facial shield support around a head of a user; or
the adjustment device, which tightens the facial shield support around a head of a user, the adjustment device being integrated with the hood portion and being adapted to also tighten the hood portion around a head of a user; or
the adjustment device which tightens the facial shield support around a head of a user, the adjustment device being integrated with the hood portion and being adapted to also tighten the hood portion around a head of a user, the hood portion being the facial shield support; or
an elastic material being a part of the hood portion and configured to tighten the hood portion around a head of the user and to prevent the inflation of the hood portion by an inner air pressure; or
an elastic material being a part of the hood portion and configured to tighten the hood portion around a head of the user and to prevent the inflation of the hood portion by the inner air pressure, the hood portion being simultaneously the facial shield support and the respective adjustment device.

4. The ventilated cooling and protective garment according to claim 1 further comprising at least a portion, or at least a torso portion, of the partial or complete body portion is configured to generate a cooling airflow close to the body of the user by being:
adapted to be tightened around the body of the user; or
adapted to be tightened around the body of the user by an additional adjustment device; or
made of an elastic material configured to tighten the protective garment around a body of the user and to prevent the inflation of the protective garment by the inner air pressure.

5. The ventilated cooling and protective garment according to claim 1 wherein an inner side of the hood portion and/or of the partial or complete body portion comprises a plurality of discrete protruding spacer nodes.

6. The ventilated cooling and protective garment according to claim 1 wherein the facial peripheral connector includes a releasable seal selected among a zipper seal, a magnetic seal, a Velcro seal or a snap fit seal, the facial peripheral connection configured to allow a separation of the transparent shield from the protective garment.

7. The ventilated cooling and protective garment according to claim 1 wherein the air outlet of the facial shield is integrated in the facial peripheral connector.

8. The ventilated cooling and protective garment according to claim 1 wherein at least a portion of the protective garment comprises an inner perforated layer spaced from the outer layer by a plurality of discrete protruding spacer nodes, an air source being connectable to the space defined between the outer layer and the inner perforated layer, an inner side of the inner perforated layer also comprises a plurality of discrete protruding spacer nodes.

9. The ventilated cooling and protective garment according to claim 1 wherein the ventilated cooling and protective garment is connected to a wearable autonomous air supply.

10. The ventilated cooling and protective garment according to claim 1 further comprising an annular track formed on the transparent shield as an integral part thereof and made of the same material as the transparent shield, the facial peripheral connector being attached and retained to the annular track through an annular coupling configuration complementary to the annular track and tightly fitted thereto.

11. The ventilated cooling and protective garment according to claim 10 wherein the annular track is defined in an inner side of the transparent shield and is directed towards the facial opening, and the transparent shield extends beyond the annular track on the upper region thereof defining an upper support intended to be vertically supported on a top area of the user head, either directly or through an intermediate padding element attached to an inner side of the upper support.

12. The ventilated cooling and protective garment according to claim 10 wherein:
the transparent shield is made of a plastic sheet; or
the transparent shield is made of a thermoformed plastic sheet, the annular track being formed by bends of the plastic sheet; or
the transparent shield is made of a molded plastic, the annular track being molded on the plastic.

13. The ventilated cooling and protective garment according to claim 1 wherein the transparent shield comprises, on at least one of its surfaces, at least one of the following: an anti-scratch treatment; an anti-fog treatment; a hydrophobic treatment; an anti-microbial treatment; an anti-bacterial treatment; an anti-glare treatment; a light filtering treatment; or a photo-chromic treatment.

14. The ventilated cooling and protective garment according to claim 1 wherein the facial shield further comprises at least one of the following features, connected to a battery and to a control unit: a handsfree microphone and/or speaker; a head-up display; a front-facing camera; a user-facing camera; outer temperature and/or pressure sensor; inner temperature and/or pressure sensor; user temperature, breathing and/or cardiac sensor; wireless connection antenna; or a battery status sensor.

15. The ventilated cooling and protective garment according to claim 14 wherein the control unit is connected to the air supply connected to the cooling and protective garment and is configured to regulate the insufflated air flow in response to temperature measurements, breathing and/or cardiac measurements obtained from the sensors.

16. The ventilated cooling and protective garment with facial shield according to claim 1 wherein the protective garment comprises an outer layer made of a woven textile or a non-woven textile with a hydrophobic, anti-microbial and/or anti-bacterial characteristics, and/or wherein the protective garment further includes non-ventilated garment portions, made of air impermeable or air semi-impermeable material, connected to the body part openings of the partial body portion.
